(19) United States
(12) Patent Application Publication
(10) Pub. No.: US 2009/0056957 A1
(43) Pub. Date: Mar. 5, 2009

(54) Method and apparatus for improving fire prevention and extinguishment

(76) Inventor: Peter Cordani, Palm Beach Gardens, FL (US)

Correspondence Address: MCHALE & SLAVIN, P.A., 2855 PGA BLVD, PALM BEACH GARDENS, FL, 33410, US

(21) Appl. No.: 12/270,485

(22) Filed: Nov. 13, 2008

Related U.S. Application Data
(63) Continuation-in-part of application No. 11/680,803, filed on Mar. 1, 2007.

(51) Int. Cl. A62C 35/02; B01F 5/04

(52) U.S. Cl. 169/15; 137/888

(57) ABSTRACT

The instant invention relates to an apparatus and method for fire extinguishment and retardation. The method comprises of a means for introducing polymeric material to a flow of water from an outside source before the flow of water enters a pumping unit within a mobile fire fighting apparatus, thereby forming a mixture of water and polymeric material. An eductor assemblage provides a means of introducing the polymeric material to the flow of water. The eductor assemblage comprises of a hopper and an eductor member. The hopper contains an amount of polymeric material, specifically super absorbent polymers. The eductor member comprises of an inlet connectable to the outside source of water, an outlet in fluid communication with the inlet and connected to the intake on a mobile fire fighting apparatus, and an additive inlet positioned between the inlet and outlet. The additive inlet is connected to the hopper and in fluid communication with the eductor member wherein a flow of the source of water from the inlet to outlet educts the super absorbent polymers through the additive inlet by venturi and flows into the eductor member forming a mixture for dispensing through the outlet onto combustible sources.

### CROSS REFERENCE TO RELATED APPLICATION

This application is a continuation-in-part of U.S. patent application Ser. No. 11/680,803, filed Mar. 1, 2007, the contents of which are herein incorporated by reference.

### FIELD OF THE INVENTION

This invention relates to fire fighting and in particular to an apparatus and method for introducing a super absorbent polymer into a mobile fire fighting apparatus in an amount sufficient to extinguish and prevent conflagrations.

### BACKGROUND OF THE INVENTION

Water is well known for its fire extinguishing properties and remains the predominate material used to extinguish or prevent certain types of fires. Water has a high heat capacity and high heat of vaporization, such that when water is sprayed onto a fire, the water that reaches the flames absorbs the heat of the fire and cools the article to below its combustion temperature. Water also deprives the fire of oxygen. Often the heat of the fire turns a portion of water into vapor before it can reach the flames. Since water vapor is heavier than air it displaces the oxygen surrounding the fire, thereby suffocating the fire.

The use of water for fire prevention is none more prevalent than when used in firefighting rescue operations. In emergency situations in urban areas, a hose is attached to a fire hydrant, then the valve on the hydrant is opened to provide a low pressure source of water to a fire engine. The fire engine, which contains a pumping unit, boosts the water pressure where it can be split into multiple streams for eventual dispensing through a nozzle and unto combustible sources. In emergency situations in rural or forestry areas, a water tender, which is designed to carry loads of up to 1000 gallons or more is used as a source of water. Water tenders are useful in rural or forestry areas because fire hydrants generally not readily available in these areas. Alternatively in rural or forestry areas, an alternate water supply (e.g. lake, river, stream, swimming pool) may be used as a source of water. However, water tenders and/or alternate water supplies normally do not have sufficient water pressure to produce a steady stream of water to douse a fire; therefore a mobile fire fighting apparatus with a pumping unit is ultimately needed. Thus the mobile fire fighting apparatus with a more powerful pumping unit converts the water from a tender or alternative water supply into a high pressure stream to be used for spraying water from a nozzle towards combustible sources.

The firefighting systems, described above, comprise of a mobile fire fighting apparatus having a pumping unit within for pumping water from a source and dispensing the water at a higher pressure through a nozzle at combustible sources. However, water alone is ineffective for retarding and extinguishing fires. A significant disadvantage often encountered using water to extinguish a fire is that much of the water ends up being wasted. Most of the water applied directly to the fire is turned into steam and evaporates before it can reach the base of the fire, where the combustible fuel for the fire resides. As much as 90 to 95% of the water that does manage to reach the flames simply runs off into the ground without remaining on the structure that is burning. Moreover, considerable effort must be made to continuously soak objects with water near the fire that could ignite. The evaporated and runoff water must be constantly replaced.

To increase effectiveness in fire extinguishment and retardation the use of chemical or foam additives have been introduced into the water line exiting the pumping unit within the mobile fire fighting apparatus. Some firefighting systems use additive pumps for forced injection of the chemical into the water line, while other systems use eductor valves relying on the movement of the water through a plenum chamber to educe the chemical or foam to the water line. More importantly, these additives have been integrated into the water line after the water has passed through the pumping unit within the mobile fire fighting apparatus. Unfortunately, adding the additive after the water has passed through the pumping unit within the mobile fire fighting apparatus has several drawbacks. For instance, U.S. Pat. No. 7,367,361 B2 discloses an eductor assembly for use with firefighting equipment that comprises an eductor body defining a fluid inlet connectable to a source of a firefighting fluid, a fluid outlet for dispensing, and an additive inlet connectable to a source of additive. The additive is educed to mix with the high pressure water under venturi flow. The hose attachable to the inlet is coming from pumping unit in the fire engine; and the hose attachable to the outlet terminates at a nozzle. Thus the eductor assembly is installed after the fluid leaves the pumping unit. Assortments of drawbacks are associated with the use of this device. Firstly, the device requires time for coupling the eductor body the inlet and the outlet; and regrettably, in firefighting rescue operations wasted time spent installing an eductor assembly maybe the difference in saving several lives. Secondly, the additive may not be fully admixed with the water line in the short distance it travels from the point of addition at the additive inlet to the nozzle end, thus possibly creating a mixture with a high viscosity having a tendency to clog the lines and cause a weak stream rendering the additive ineffective. Thirdly, using chemical or foam additives requires a cleaning process after use so the additive does not harden or solidify within the hoses, eductor, or nozzle.

Some of the disadvantages associated with introducing additives to the water line maybe be resolved if the additive were to be introduced by some means before entering the pumping unit within a mobile fire fighting apparatus. However, if a chemical or foam additive were to be added before entering the pumping unit in the mobile fire fighting apparatus concerns arise. Specifically concerns regarding clogging of the water line, clogging of the pump, or left behind harden residue which may potentially destroy the pumping unit or hoses still exists.

For instance, U.S. Pat. No. 5,989,446 discloses a water additive for use in fire extinguishing and prevention. The additive comprises a cross-linked water-swellable polymer in a water/oil emulsion that is produced by an inverse phase polymerization reaction. The polymer particles are dispersed in an oil emulsion wherein the polymer particles are contained within discrete water “droplets” within the oil. With the help of an emulsifier, the water “droplets” are dispersed relatively evenly throughout the water/oil emulsion. This allows the additive to be introduced to the water supply in a liquid form, such that it can be easily educted with standard firefighting equipment. However, it has been observed that this additive takes approximately 3-4 hours to “cure” such that it is able to absorb a sufficient amount of water and attain the viscosity necessary to adhere to vertical and horizontal surfaces for firefight purposes. Also, if the additive/water mixture is not completely flushed from a hose or nozzle after use, it will harden upon drying out and render the hose or nozzle useless. While these prior arts may be suitable for the particular purpose to which they address, these prior arts would not be suitable for the purposes of the present invention as heretofore described.

What is lacking in the art is a need to increase the effectiveness of water for firefighting by integrating an apparatus and method for introducing fire retardant particles to a source of water before entering a pumping unit within a mobile fire fighting apparatus, whereby the fire retardant particles do not clog the hoses or pumping unit, do not require “curing”, do not harden or solidify, maintain a viscosity similar to water, and need not be cleaned after use.

### SUMMARY OF THE INVENTION

The instant invention discloses an apparatus and method for introducing super absorbent polymers to a flow of water from an outside source thereby forming a mixture of water and super absorbent polymers before the flow of water enters the pumping unit within a mobile fire fighting apparatus.

The instant invention discloses an eductor assemblage device comprising at least one hopper and an eductor member. The eductor member is positioned between a pumping unit within a mobile fire fighting apparatus and an outside source of water. The eductor member has an inlet connectable to the outside source of water, an outlet in fluid communication with the inlet of the pumping unit, and at least one additive inlet integrated into the eductor. The hopper contains super absorbent polymer and is connected to the additive inlet. The additive inlet is in fluid communication with the eductor member wherein a flow of the outside source of water from the inlet to the outlet on the eductor member draws the super absorbent polymers through the additive inlet by venturi. The super absorbent polymers flow into the eductor member forming a mixture within for dispensing through the outlet. The mixture is dispensed through the outlet to a pumping unit in a mobile fire fighting apparatus and discharged onto a source of combustible material for fire extinguishment or retardation. The eductor assembly further includes a valve positioned between the additive inlet and the hopper wherein the valve is infinitely adjustable for regulating the flow of super absorbent polymers into the eductor member.

The super absorbent polymers are prepared from water-soluble polymers, but have cross-linking structures that render the polymers water-insoluble. By taking water-soluble ethylenically unsaturated monomers which readily undergo vinyl polymerization, such as acrylamide, with cross-linking agents, a polymer can be produced that is of uniform small size, has a high gel capacity, is highly insoluble, but highly water-swellable (i.e., super absorbent polymer). The gel capacity refers to the property of the water-swollen polymer to resist viscosity changes as a result of mechanical working or milling.

Accordingly, it is an objective of this invention to present an apparatus and method that uses super absorbent polymers to transform water into a gel-like substance effective for fire extinguishment or prevention. This super absorbent polymer gel will bring fires under control more quickly, offering substantially less water consumption and substantially more time saving. The super absorbent polymer gel may be applied to any source of combustible material in anticipation of a fire for fire retardation or directly at a source of combustible material already flaming for fire extinguishment.

Yet another objective of the present invention is to provide a device used in conjunction with an outside source of fluid and a mobile fire fighting apparatus' pumping unit to combat fires in an effective manner. More specifically, where the eductor member inlet is connectable to an outside source of fluid; and where the outlet is connectable to a hose leading to a pumping unit within a mobile fire fighting apparatus or an intake on a mobile fire fighting apparatus leading to a pumping unit. The outside source of fluid includes sources such as naturally occurring bodies of water, existing water supplies, and transportable water supplies. Examples include fire hydrants, water tender, lakes, rivers, water pools, drop tanks, swimming pools, etc.

Yet another objective of the present invention is to teach a hydrated super absorbent polymer having a viscosity that allows the polymers to be emptied through the additive inlet and the gel to be dispensed from the outlet of the eductor member without clogging or blocking. Furthermore the hydrated super absorbent polymer gel has a viscosity that allows the gel to travel within standard firefighting equipment (e.g., fire hoses, nozzles, pumping unit etc.).

Yet another objective of the present invention is to have an admix chamber within the eductor member defining a plenum. When the outside source of fluid comes through the inlet it educes the super absorbent polymers from the additive inlet into the eductor member, thus providing an admix chamber.

Another objective of the instant invention is to introduce super absorbent polymers to an outside source of fluid which will not leave behind a residue, will not harden or solidify, and will not require time to “cure” before entering a pumping unit within a mobile fire fighting apparatus therefore clearly highlighting the inventiveness of the invention.

Another objective of the instant invention is the use of an eductor assembly which provides continuous use of polymer when a flow of fluid is the primary source of water replenishment creating a venturi effect within the eductor member. Therefore as long a flow of water is running through the eductor member and the hopper retains an amount of super absorbent polymer there will be a continuous stream of the gel-like mixture dispensing from the eductor outlet. The only maintenance required is re-filling the hopper.

Another objective of the instant invention is to use super absorbent polymers which lubricates the pumping unit.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE DRAWINGS

FIG. 1 illustrates a pictorial representation of an exemplary device;

FIG. 2 illustrates a pictorial representation of a mobile fire fighting apparatus equipped with an eductor assemblage for introducing super absorbent polymer for extinguishment or retardation of fire;

FIG. 3 illustrates a pictorial representation of the back end of the mobile fire fighting apparatus equipped with an eductor assemblage for introducing super absorbent polymer for extinguishment or retardation of fire;

FIG. 4 illustrates a side view of an eductor body;

FIG. 5 illustrates an alternative polymeric delivery device;

FIG. 6 illustrates an alternative polymeric delivery device;

FIG. 7 illustrates an alternative polymeric delivery device; and

FIG. 8 illustrates a sectional representation of the mixing area within an eductor.

### DETAILED DESCRIPTION

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representative basis for teaching one skilled in the art to various employ the present invention in virtually any appropriately detailed structure.

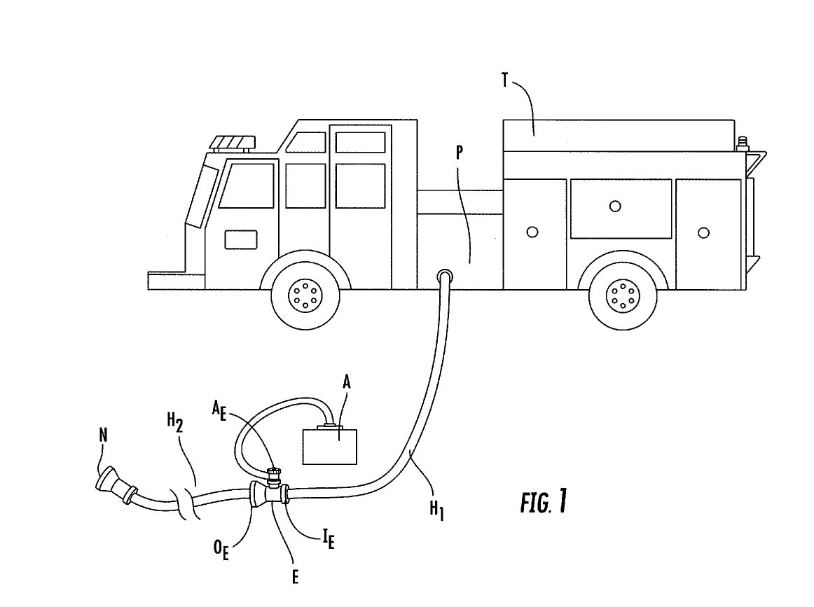

Referring now to FIGS. 1-7, wherein like elements are numbered consistently throughout. FIG. 1 illustrates one example or approach using additives for fire extinguishment and prevention. High pressure water from a pumping unit P is lead through a hose H₁ from a mobile fire fighting apparatus T to an eductor E, specifically an inlet I_{E} on the eductor member E. As the water passes through the eductor member E and exits through the outlet O_{E} on the eductor member E suction is created by venturi. The suction draws chemical or foam additive A from the additive inlet A_{E} on the eductor member E and into the eductor member E. Because a flow of water is passing through the eductor E from the inlet I_{E} to the outlet O_{E} the chemical or foam additive A is admixed with the flow of water forming a mixture. The mixture exits from the outlet O_{E} through a hose H₂ and is discharged through a nozzle N at the termination of the hose H₂ (See U.S. Pat. No. 7,367,361 B2). Important to the example described above is that the eductor system introduces additives at a point after water exits the mobile fire fighting apparatus. This system would not perform effectively if the eductor system introduced additives before entering the mobile fire fighting apparatus.

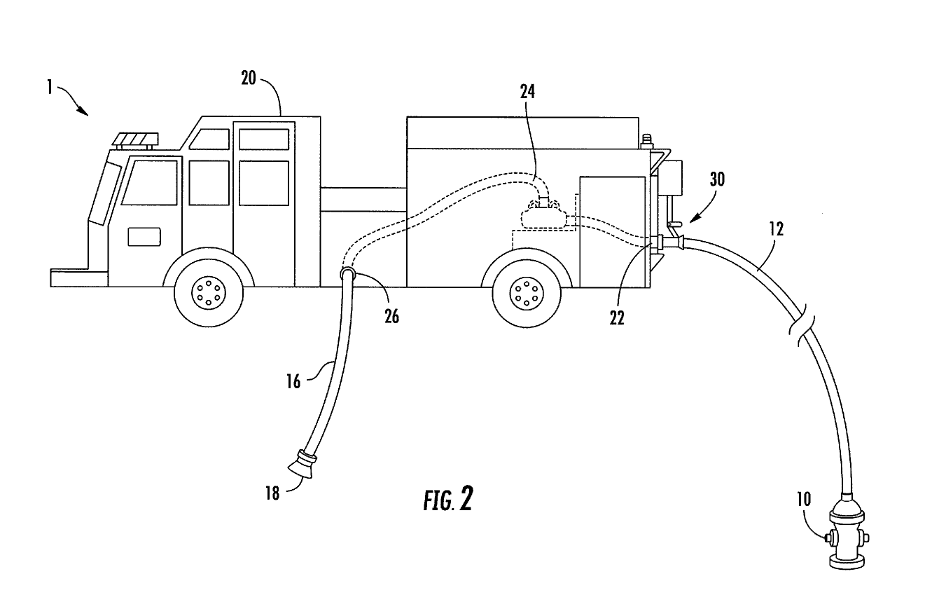

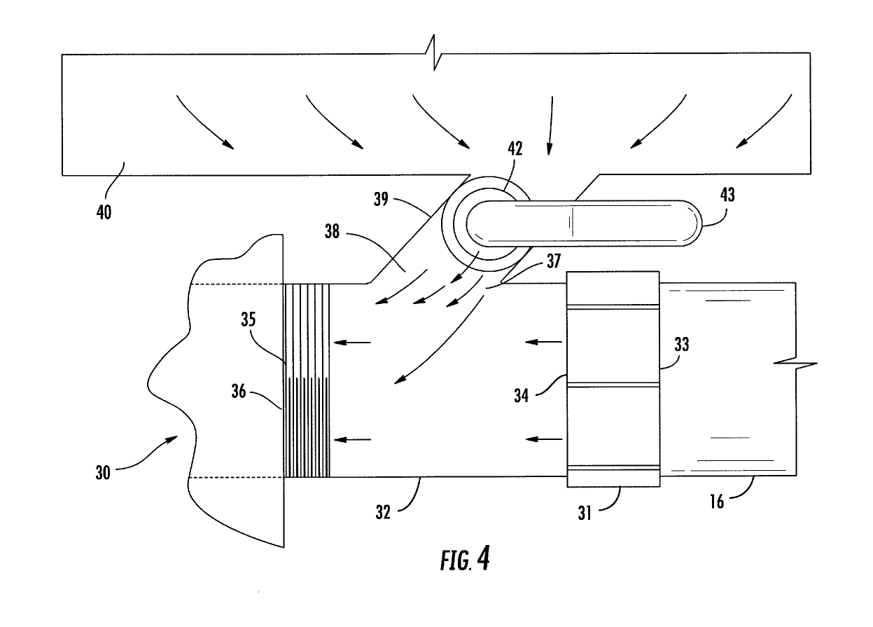

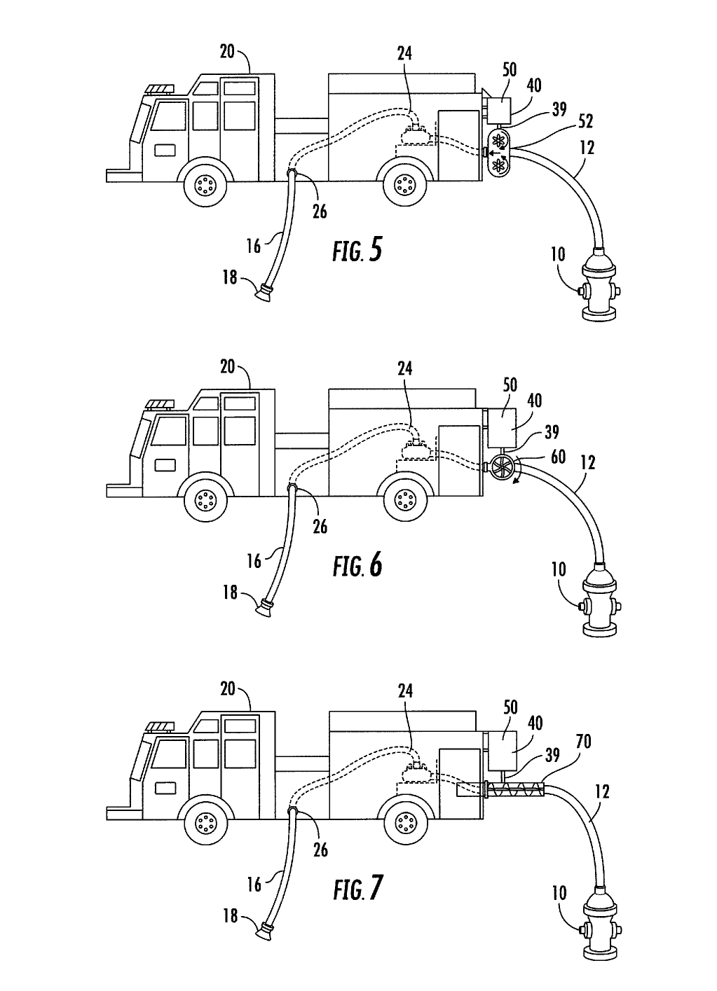

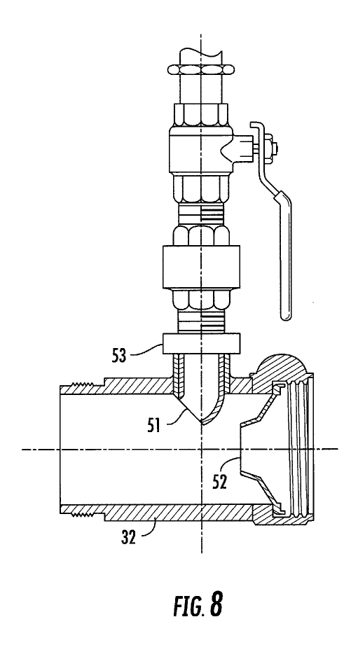

The instant invention teaches an apparatus and method of introducing polymeric material through a polymeric delivery device between an outside source of fluid and a mobile fire fighting apparatus for fire prevention and retardation. A mobile firefighting apparatus is defined as a pumping truck, ladder truck, hook and ladder truck, water tender, wildland fire engines, fireboat, or the like. The outside source of fluid includes naturally occurring sources, existing water supplies, alternative water supplies, and transportable water supplies. Naturally occurring sources include, but are not limited, rivers, lakes, ponds or the like. Existing water supplies include, but are not limited to fire hydrants, wells, or the like. Alternative water supplies include, but are not limited to, water pools, swimming pools, drop tanks, or the like. Transportable water supplies include, but are not limited to, water tender, tankers, wildland fire tenders, or the like. The polymeric delivery device is defined as a means for introducing polymeric material to a flow of fluid for admixing. The polymeric delivery device includes a positive displacement pump (shown in FIG. 5), a dynamic pump (shown in FIG. 6), an eductor device (shown in FIGS. 2-4), a conveyor (shown in FIG. 7), or the like. The conveyor includes device such as yoke conveyors, screw conveyors, or the like. The positive pressure pump includes devices such as a pressurized bladder, lobe pumps, gear pump, single rotor pump, multiple rotor pump, or the like. Educed devices include devices such as eduction valves, aspirator valves, or the like. The dynamic pump device includes devices such as centrifugal pumps or the like. Alternative polymeric delivery devices include an automatic direct injection device.

The polymeric material is a dehydrated super absorbent polymer. Super absorbent polymers have properties distinct from other chemical or foam additives which are typically introduced to water hose lines in an attempt to extinguish fire. The present invention relates to a process of retarding or extinguishing conflagrations using super absorbent polymers in water in an amount sufficient to retard or extinguish the fire. The present invention utilizes biodegradable super absorbent aqueous based polymers, for example, cross-linked modified polyacrylamides, potassium acrylate, polyacrylamides, sodium acrylate commercially available from Stockhausen, Inc. (Greensboro, N.C.). Other suitable polymers include, albeit are not limited to, carboxy-methylcellulose, alginic acid, cross-linked starches, and cross-linked polyaminoacids. In the present invention, a solid form of the super absorbent polymer, such as powder, is introduced into a standard fire fighting system.

Super absorbent polymers are capable of absorbing water up to several thousand times its own weight. These super absorbent polymers are prepared from water-soluble polymers, but have cross-linking structures that render the polymers water-insoluble. By taking water-soluble ethylenically unsaturated monomers which readily undergo vinyl polymerization, such as acrylamide, with cross-linking agents, a polymer can be produced that is of uniform small size, has a high gel capacity, is highly insoluble, but highly water-swellable (i.e., super absorbent polymer). The gel capacity refers to the property of the water-swollen polymer to resist viscosity changes as a result of mechanical working or milling. Super absorbent polymer particles are capable of absorbing water in significant quantities relative to its own weight, the water-swollen gel provides a greater water laden surface area, with a higher heat capacity, than the unbound water molecule. Thus, more water actually reaches the fire without being evaporated and provides more cooling. Thus, the fire is extinguished using less water. Aside from its water soluble properties super absorbent polymers do not harden or solidify after use, they do not clog water hoses, and do not require time to “cure”; for all the reasons mentioned super absorbent polymers provide firefighting system with an opportunity to introduce an additive into the water line before the water line enters the fire engine. The use of additives like super absorbent polymers allows for a transition of placing the eductor system from after the mobile fire fighting apparatus to before the fire engine.

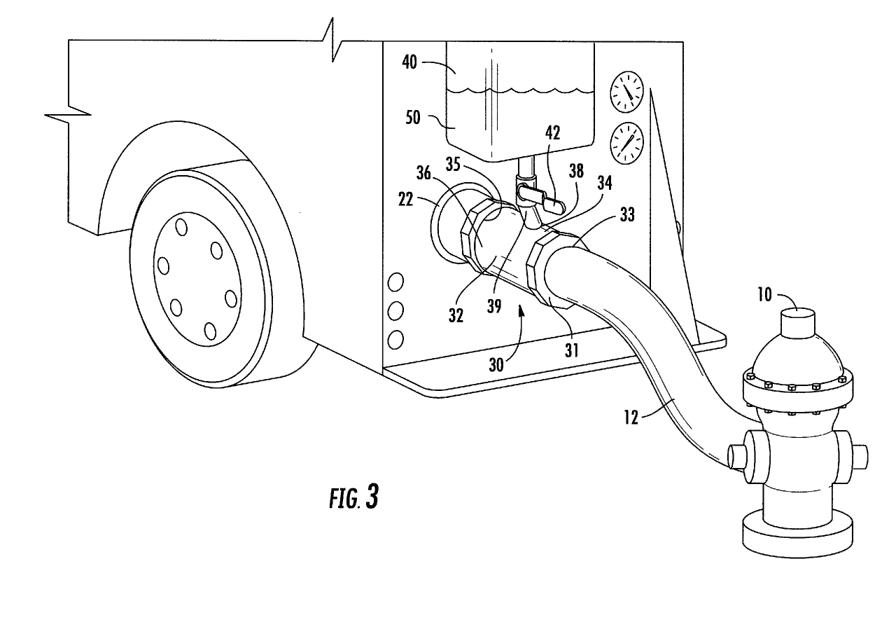

FIG. 2 illustrates the super absorbent polymer eductor fire fighting system 1. The example provided above suggested a fire hose 12 connected on one end to a source of fluid 10 and on opposite end to an intake 22 on a mobile fire fighting apparatus 20. However, the super absorbent polymer eductor fire fighting system 1 of the instant invention provides a polymeric delivery device 30 such as an eductor assemblage (more aptly shown in FIG. 3) installed between the outside source of fluid 10 and the intake 22 on the mobile fire fighting apparatus 20. The intake 22 leads to a pumping unit 24 that pumps water under high pressure from the outside source of fluid 10 to an outtake/outlet valve 26. On a mobile fire fighting apparatus 10, such as a fire engine shown in FIG. 2, a second fire hose 16 terminating in a nozzle 18 is connected to the outlet valve 26. The nozzle 18 discharges a stream of fire extinguishing or retardant fluid. However, on a mobile fire fighting apparatus 10, such as a water tender, once the fire extinguishing or retardant fluid runs through the pumping unit 24 the fire extinguishing or retardant fluid is not discharged, the fire extinguishing or retardant fluid is maintained in a water reservoir/tanker for use where a source of water is not readily available.

As shown in FIGS. 3 and 4, the eductor assemblage 30 comprising of an eductor member 32 and a hopper 40. The eductor member 32 has an inlet 34, outlet 36, and additive inlet 38. The eductor member 32 is hollow within and defines a plenum chamber for containing fluid at a positive pressure. The eductor member 32 has a cylindrical 2½″ cross section throughout. The inlet 34 on the eductor member 32 is in fluid communication with the outlet 36 on the eductor member 32. The inlet 34 has a 2½″ opening 33 and a collar 31. The collar 31 is a ball bearing mounted internally threaded ring. The 2½″ opening 33 and collar 31 are to adapt to fit a standard fire hose 12. The inlet 34 is arranged to receive a flow of pressurized fluid coming from a source 10. The outlet 36 is in fluid communication with the inlet 34 and also receives the flow of pressurized fluid. The outlet 36 has an opening 35 sized for connection to the intake 22 on the mobile fire fighting apparatus 20, more specifically a 2½″ externally threaded opening 35. The threading on the inlet and outlet shall comply with the National Hose threads, discussed below, if the device where to be used in the United States. The coupling of the intake 22 and the outlet 36 on the eductor assemblage 30 maybe permanently affixed to the mobile fire fighting apparatus 20 for ease in handling.

The 2½″ opening on the inlet and outlet, 33 and 35, respectively, on the eductor member 32 shall comply with the standards set forth by the National Fire Protection Association (NFPA). Specifically the standards set forth in NFPA 1901: Standard for Automotive Fire Apparatus. As most mobile fire fighting apparatuses are equipped with an intake having a 2½″ internal National Hose threadings collar sized to adapt to a fire hose having a 2½″ National Hose threaded opening, the eductor assemblage in the instant invention is sized to fit both the intake on the mobile fire fighting apparatus and a standard fire hose. Should there be any changes or differences in sizing on an intake or fire hose, then the eductor member's inlet and outlet should be sized to adapt to the changes as set forth by NFPA 1901.

The intake 22 on the mobile fire fighting apparatus 20 is normally connected to a fire hose 12 coming from a source of fluid 10. However, the eductor assemblage 30, specifically the outlet 36 is adapted to connect to the intake 22 on the mobile fire fighting apparatus 30 and the inlet 34 is connected to a fire hose 12 coming from a source of fluid 10. The additive inlet 38 is positioned between the inlet 34 and the outlet 36. The additive inlet 38 comprises of an opening 37 (shown in FIG. 4) and an angled conduit 39 protruding outwardly from the opening 37 on the outer surface of the eductor member 32. The additive inlet 38 is in fluid communication with the eductor member 32, and intersects the fluid communication between the inlet 34 and outlet 36. The opening 37 is also in fluid communication with the conduit 39 and provides a port for super absorbent polymers 50 to be suctioned through by venturi. The conduit 39 is adapted to connect to a hopper 40. The hopper 40 is a container which holds 50 lbs. of super absorbent polymer 50. However, the hopper 40 maybe any size capable of holding super absorbent polymers 50. Super absorbent polymers 50 are educed from the hopper 40 by venturi, more specifically water from a source 10 passes through the eductor inlet 34 and into the eductor member 32 where it creates an area of low pressure; this low pressure educes the super absorbent polymers 50 through the additive inlet 38 and into the flow of water. To educe is defined as that which is educed by drawing or bring out. In the preferred embodiment, the additive inlet 38 is positioned vertically above the eductor member 32 and the hopper 40 is normally positioned vertically above the additive inlet 38. This arrangement allows gravity to keep the super absorbent polymers 50 near the exit of the hopper 40 so they may be drawn out of the hopper 40 and through the conduit 39 and opening 37 by venturi.

The super absorbent polymers 50 and the flow of outside source of fluid admix within the eductor member 32. When the super absorbent polymers 50 are introduced to the flow of fluid within the eductor member 32 through venturi the super absorbent polymers 50 admixes with the water creating an admix chamber within the eductor member 32. The turbulence created by the flow of water within the eductor member's interior walls admixes the super absorbent polymers 50 with the water creating a mixture. The mixture is a gel-like substance comprising of fluid and super absorbent polymers 50.

A valve 42 is positioned on the conduit 39 between the hopper 40 and the opening 37. In the preferred embodiment a ball valve is used, however, a butterfly valve, control valve, diaphragm valve, pinch valve, or the like is contemplated. The valve 42 is infinitely adjustable. The ball valve operates between an open position, a closed position, and an infinitely adjustable position thereinbetween. FIG. 8 is a sectional illustration of a housing 32 having eductor outlet 51 positioned after baffle 52 to assure the proper mix/flow required. Also included is a safety feature 53 to indicate the precise tie which allows the polymer passage into the housing 32. The process reduces back flow water and associated line clogging. The closed position prevents the back flow of fluid from entering the hopper 40 and prevents super absorbent polymers 50 from being educed through the additive inlet 38. In an open position, super absorbent polymers 50 are permitted to be educed by the flowing fluid within the eductor member 32 by venturi. In the infinitely adjustable position thereinbetween, the valve 42 regulates the amount of super absorbent polymers 50 flowing through the additive inlet 38, thus allowing the operator to manually determine the flow of super absorbent polymers 50 through the additive inlet 38. The valve 42 includes a handle 43 for operation thereof. The handle 43 is rotatable to operate the valve 42. The handle 43 extends from the conduit 39 thereof.

Furthermore it is also contemplated that use of a check valve may be employed on the conduit between the valve and the additive inlet. The check valve allows fluid to flow through it in only one direction, without being manually operated. The check valve comprises of a valve seat and a valve body pushed onto the valve seat. Thus, the check valve allows the passage of only the fluid which forces the body away from the seat. Any fluid that flows in the opposite direction applies back pressure to the body, pressing the body onto the seat and not allowing the fluid to pass therethrough. In the instant invention the super absorbent polymers would force the body away from the seat allowing the super absorbent polymers to pass through conduit and opening and into the eductor member. The flow of outside source of fluid would apply back pressure on the body preventing the passage of fluid through the check valve and into the hopper.

Alternative embodiments of the eductor assemblage contemplate the use of two additive inlets placed opposite each other. Both additive inlets being in fluid communication with the eductor member and intersecting the inlet and outlet. The use of a double additive inlet requires a double hopper system. The use of a double hopper system allows firefighters to easily switch from one hopper to the other when the other is emptied. The switching of hoppers is made easy by closing the valve on the first hopper and then subsequently opening the valve on the second hopper to allow for super absorbent polymers to be drawn from the second hopper. However, the hoppers maybe positioned in a manner whereby they are not capable of using gravity to keep the super absorbent polymers near the exit of the hopper in order to be drawn out by suction thus not capable of being educed by the eductor. When this is the case, the pumping unit within the mobile fire fighting apparatus will have to be powerful enough to suction not only the stream of water through the eductor member but also super absorbent polymers from the hopper. Otherwise a piston, pump, or the like may be used to introduce the super absorbent polymers to the flow of fluid. Also, other alternative embodiments may have the additive inlets positioned adjacent each other, in this configuration; both hoppers will be placed vertically above the eductor member. By placing the hoppers vertically above the eductor member gravity is able to keep the super absorbent polymers near the exit in order to be drawn out by venturi.

A non-limiting illustrative example is presented herein; the following is only an example and not solely representative of the inventive concepts discussed herein. On a mobile fire fighting apparatus an eductor assemblage was installed. Approximately 50 pounds of a superabsorbent aqueous based polymer was placed within a hopper, introduced to a flow of 500 gallons of water at a rate between 30-100 psi through the eductor member by venturi, the water and super absorbent polymers are admixed together to form a mixture, and exited through the outlet on the eductor member. The viscosity did not cause the polymer to aggregate or prevent eduction through the 2½″ eductor member and a standard fire hose.

FIGS. 5-7 illustrate alternative embodiments of the polymeric delivery device. The polymeric delivery devices illustrated are positioned between the outside source of fluid 10 and the intake 22 on the mobile fire fighting apparatus 20. The alternative embodiments employ the use of a hopper 40 to contain the polymeric material 50 within and introduce the polymeric material 50 into the polymeric delivery device. The hopper 40 uses gravity forces to allow the polymeric material 50 to be introduced into the polymeric delivery device. The polymeric devices described are alternatives to the use of the eductor assembly described above. It should be understood that various alternative embodiments are contemplated to achieve the general objective for introducing super absorbent polymers between the outside source of fluid and pumping unit in the mobile fire fighting apparatus through a polymeric delivery device. Any permutations or considerations to the alternative embodiments in FIGS. 5-7 should be incorporated from the language describing the preferred embodiment of an eductor assembly above.

FIG. 5 shows a positive displacement pump 52. The positive displacement pump 52 has an expanding cavity on the suction side of the pump 52 and a decreasing cavity on the discharging side of the pump 52. The polymeric material 50 is introduced into the pump 52 as the cavity on the suction side expands and the polymeric material 50 is forced out the discharge as the cavity collapses. All the while a flow of outside source of fluid 10 is flowing through the positive displacement pump 52 and admixing with the polymeric material 50 forming a mixture, until it is discharged into the intake 22 on the mobile fire fighting apparatus 20. FIG. 6 shows a dynamic pump 60, whereby polymeric material 50 is introduced into the impeller within the dynamic pump 60 and a flow of outside source of fluid 10 is flowing through the into the impeller within the dynamic pump 60. The impeller produces a velocity with the mixture of polymeric material 50 and outside source of fluid 10 and the volute forces the mixture to discharge from the dynamic pump 60 converting velocity to pressure and into the intake 22 on the mobile fire fighting apparatus 20. FIG. 7 shows a conveyor 70, whereby the outside source of fluid 10 flows through the conveyor trough from the inlet to the outlet; in between the conveyor inlet and outlet the polymeric material 50 is introduced. The polymeric material 50 is introduced into the polymeric delivery devices from the hopper 40 by gravity forces through a conduit 39 in between the hopper 40 and the polymeric delivery device. FIG. 8 is a sectional illustration of a housing 32 having eductor outlet 51 positioned after baffle 52 to assure the proper mix/flow required. Also included is a safety feature 53 to indicate the precise tie which allows the polymer passage into the housing 32. The process reduces back flow water and associated line clogging.

The super absorbent polymers can be dehydrated to a powder. When the powder is added to an aqueous solution and agitated, a super absorbent gel-like substance is formed. In a dry state the preferred polymer may be considered a particle having a diameter less than 4000 microns but greater than 50 microns. In a swollen state the particle may have a diameter greater than three hundred times its original diameter in a dry state (more surface area). In a totally water-swollen state, the particles contain up to 99.98 weight percent of water and as little as about 0.1 weight percent of polymer. Thus, such particles could hold an amount of water from ten to thousands of times their own weight.

Without wishing to be bound to any particular theory it is believed that the since the polymer particles are capable of absorbing water in significant quantities relative to its own weight, the water-swollen gel provides a greater water laden surface area, with a higher heat capacity, than the unbound water molecule. More water actually reaches the fire without being evaporated and provides more cooling. Thus, a fire can be extinguished using less water.

The reaction of the water with the polymer creates a gel-like substance with a viscosity that allows the mixture to be readily pumped through standard eduction equipment and pumping unit, yet viscous enough to cover and adhere to vertical and horizontal surfaces of structures to act as barrier to prevent fire from damaging such structures, minimizing the manpower and water supply needed to continuously soak these structures.

It should be noted that the super absorbent polymer and water of the instant invention may create a slippery surface; in such instances, a small amount of grit may be added to the super absorbent polymer if it is to be used in an area that will be traversed by individuals such as exit corridors or where fireman are expected to travel by foot or vehicle.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and drawings/figures.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention. Although the invention has been described in connection with specific preferred embodiments, it should be understood that the invention should not be unduly limited to such specific embodiments.

What is claimed is:

1. A method for improving the effectiveness of a mobile fire fighting apparatus used in fire prevention and extinguishment comprising:
inserting an admixture of polymeric material and raw water into a mobile fire fighting apparatus;
storage of said admixture in said mobile fire fighting apparatus; and
discharging said admixture from said mobile fire fighting apparatus onto combustible material for fire prevention and fire extinguishment.

2. The method according to claim 1 wherein said step of inserting an admixture of polymeric material includes an eductor for drawing said polymeric material into said raw water for admixing before storage.

3. The method according to claim 2 including a step of pumping said raw water into said mobile fire fighting apparatus, said eductor positioned between a raw water source and said mobile fire fighting apparatus.

4. The method according to claim 1 wherein said polymeric material is a dry dehydrated super absorbent polymer.

5. The method according to claim 4 wherein said dehydrated super absorbent polymer is selected from the group consisting of cross-linked modified polyacrylamides, potassium acrylate, polyacrylamides, sodium acrylate, carboxy-methylcellulose, alginic acid, cross-linked starches, and cross-linked polyaminoacids.

6. The method according to claim 2 including a step of attaching a hopper to said eductor, said hopper available for receipt of said polymer.

7. The method according to claim 1 including a step of inserting a predetermined amount of polymer into said raw water.

8. An eductor assemblage for use in combination with a mobile fire fighting apparatus comprising:
an eductor member having an inlet fluidly coupled to a raw water source and a outlet fluidly coupled to a mobile fire fighting apparatus, said eductor having an additive inlet port;
a hopper containing a source of polymeric material coupled to said additive inlet;
wherein a flow of raw water through said eductor inlet draws polymeric material forming admixture for insertion into said mobile fire fighting apparatus, said admixture available for discharging from said mobile fire fighting apparatus onto a source of combustible material.

9. The eductor assemblage according to claim 8 including an adjustable metering valve positioned between said additive inlet port and said hopper, said valve adjustable to regulate the flow of said polymeric material through said additive inlet port.

10. The eductor assemblage according to claim 8 wherein said eductor member inlet and outlet is a 2½″ inch conventional fire hose coupling with a hollow plenum chamber having a substantially cylindrical cross-section therethrough.

11. The eductor assemblage according to claim 8 wherein said conventional fire hose coupling includes an external collar having a ball bearing mounted internally threaded ring.

12. The eductor assemblage according to claim 8 including a baffle, said baffle juxtapositioned to the eductor output to reduce backflow water and assure proper mixing.

13. An eductor assemblage for use in combination with a mobile fire fighting apparatus comprising:
an eductor member having a 2½″ inch inlet with an external collar formed from a ball bearing mounted internally threaded ring fluidly for coupling to a raw water source and a 2½″ inch outlet fluidly with external threads for coupling to a mobile fire fighting apparatus, said eductor having an additive inlet port and eductor output;
a baffle juxtapostioned to said eductor output;
a hopper containing a source of polymeric material coupled to said additive inlet;
wherein a flow of raw water through said eductor inlet draws polymeric material forming a mixture for insertion into said mobile fire fighting apparatus, said mixture available for discharging from said mobile fire fighting apparatus onto a source of combustible material.
